(19) United States
(12) Patent Application Publication
(10) Pub. No.: US 2022/0013087 A1
(43) Pub. Date: Jan. 13, 2022

(54) METHODS AND APPARATUS FOR DISPLAY PROCESSOR ENHANCEMENT

(71) Applicant: QUALCOMM Incorporated, San Diego, CA (US)

(72) Inventors: Dileep MARCHYA, Hyderabad (IN); Srinivas PULLAKAVI, Kakinada (IN); Padmanabhan KOMANDURU V, Hyderabad (IN)

(21) Appl. No.: 16/924,052

(22) Filed: Jul. 8, 2020

(51) Int. Cl. G09G 5/36; G09G 5/377; G09G 5/395

(52) U.S. Cl. CPC G09G 5/363; G09G 5/377; G09G 5/395; G09G 2370/00; G09G 2310/08; G09G 2310/04; G09G 2360/18

(57) ABSTRACT

The present disclosure relates to methods and apparatus for display processing. The apparatus can receive a first frame at a frame ready time associated with a current vertical synchronization (Vsync) time period including a first Vsync time and a second Vsync time, the frame ready time may be between the first Vsync time and the second Vsync time, the current Vsync time period may be distinct from one or more application Vsync time periods. The apparatus can also determine one of the one or more application Vsync time periods to align with the current Vsync time period based on the frame ready time. Moreover, the apparatus can adjust an alignment of the current Vsync time period to align with the one of the one or more application Vsync time periods. The apparatus can also adjust the second Vsync time to align the current Vsync time period.

### TECHNICAL FIELD

The present disclosure relates generally to processing systems and, more particularly, to one or more techniques for display or frame processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the advent of wireless communication and smaller, handheld devices, there has developed an increased need for improved graphics processing.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a compositor, a frame compositor, a frame processor, a display processor, a display processing unit (DPU), a GPU, or a CPU. The apparatus may render a first frame prior to a frame ready time. The apparatus may also receive a first frame at a frame ready time associated with a current vertical synchronization (Vsync) time period including a first Vsync time and a second Vsync time, where the frame ready time may be between the first Vsync time and the second Vsync time, where the current Vsync time period may be distinct from one or more application Vsync time periods. Additionally, the apparatus may process the first frame at the frame ready time. The apparatus may also receive a request for one or more Vsync signals based on the one or more application Vsync time periods. The apparatus may also generate the one or more Vsync signals based on the one or more application Vsync time periods. Further, the apparatus may determine one of the one or more application Vsync time periods to align with the current Vsync time period based on the frame ready time. The apparatus may also select the one of the one or more application Vsync time periods to align with the current Vsync time period based on the frame ready time. The apparatus may also calculate an alignment of the current Vsync time period to align with the one of the one or more application Vsync time periods. Moreover, the apparatus may adjust an alignment of the current Vsync time period to align with the one of the one or more application Vsync time periods. The apparatus may also adjust the second Vsync time to align the current Vsync time period with the one of the one or more application Vsync time periods. The apparatus may also send the first frame to a display panel at the second Vsync time.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example diagram of display or frame processing in accordance with one or more techniques of this disclosure.

FIG. 4 illustrates an example diagram of display or frame processing in accordance with one or more techniques of this disclosure.

FIG. 5 illustrates an example diagram of display or frame processing in accordance with one or more techniques of this disclosure.

FIG. 6 illustrates an example diagram of display or frame processing in accordance with one or more techniques of this disclosure.

FIG. 7 illustrates an example flowchart of an example method in accordance with one or more techniques of this disclosure.

### DETAILED DESCRIPTION

In some instances of display processing, adaptive variable refresh rate (AVR) mechanisms may extend a Vsync timing duration and/or trigger a Vsync signal immediately once a frame is processed or consumed. AVR mechanisms can also be used to handle intermittent sleep modes or avoid repeated frame refreshes. One problem with this use of AVR is that an application or game can expect a Vsync signal or pulse at regular multiples of a fast refresh time, e.g., 8.33 ms, 16.67 ms, or 24.99 ms. As the application may expect the Vsync signal at these times, any intermittent idling can be performed without the knowledge of the application or game. For example, if the AVR mechanism sends a Vsync signal between regular time periods, e.g., 12 ms, this may disturb or interrupt the application or game functioning. As such, if a Vsync signal is sent at an irregular interval, there may be an unaligned Vsync stretch and/or an unintended Vsync drift. These unintended Vsync drifts and unaligned Vsync stretches are undesirable for applications or games. For example, if an application or game detects an unaligned Vsync stretch, then it may try to correct the frame timing, which can result in an unintended Vsync drift. Accordingly, an unaligned Vsync transmission may result in unpredictable application or game behavior. As such, the timing between the display and the application or game may become disrupted or interrupted. So a delayed frame can cause an AVR mechanism to disrupt the timing of a frame cadence. Aspects of the present disclosure can utilize an AVR mechanism to adjust a Vsync time period to an expected Vsync timing interval. Aspects of the present disclosure can also transmit delayed Vsync signals at regular timing intervals. By doing so, the application rendering can remain synchronized with the display panel, and the frame cadence can be maintained. So the present disclosure can utilize AVR mechanisms that avoid unintended Vsync drift and/or an unaligned Vsync stretch. As such, the present disclosure can avoid unpredictable application behavior, which may interrupt the timing between the display and the application or game.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

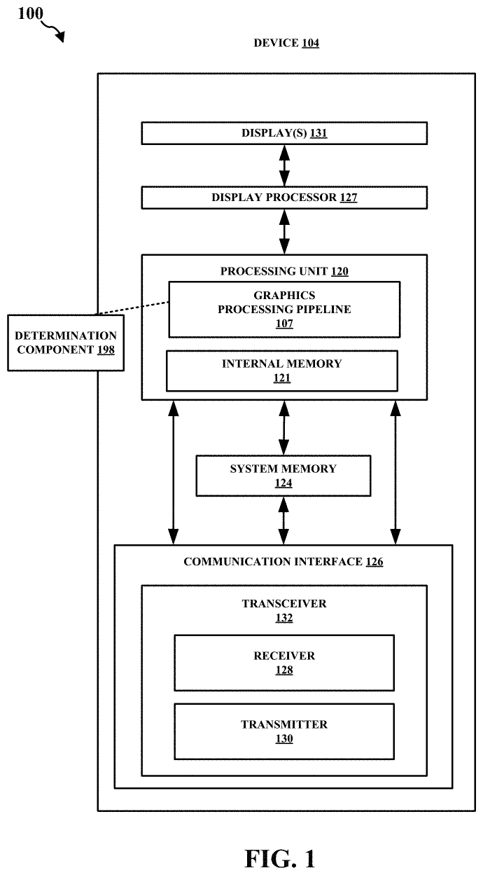

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 may be communicatively coupled to each other over the bus or a different connection.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the graphics processing pipeline 107 may include a determination component 198 configured to render a first frame prior to a frame ready time. The determination component 198 can also be configured to receive a first frame at a frame ready time associated with a current vertical synchronization (Vsync) time period including a first Vsync time and a second Vsync time, where the frame ready time may be between the first Vsync time and the second Vsync time, where the current Vsync time period may be distinct from one or more application Vsync time periods. The determination component 198 can also be configured to process the first frame at the frame ready time. The determination component 198 can also be configured to receive a request for one or more Vsync signals based on the one or more application Vsync time periods. The determination component 198 can also be configured to generate the one or more Vsync signals based on the one or more application Vsync time periods. The determination component 198 can also be configured to determine one of the one or more application Vsync time periods to align with the current Vsync time period based on the frame ready time. The determination component 198 can also be configured to select the one of the one or more application Vsync time periods to align with the current Vsync time period based on the frame ready time. The determination component 198 can also be configured to calculate an alignment of the current Vsync time period to align with the one of the one or more application Vsync time periods. The determination component 198 can also be configured to adjust an alignment of the current Vsync time period to align with the one of the one or more application Vsync time periods. The determination component 198 can also be configured to adjust the second Vsync time to align the current Vsync time period with the one of the one or more application Vsync time periods. The determination component 198 can also be configured to send the first frame to a display panel at the second Vsync time.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

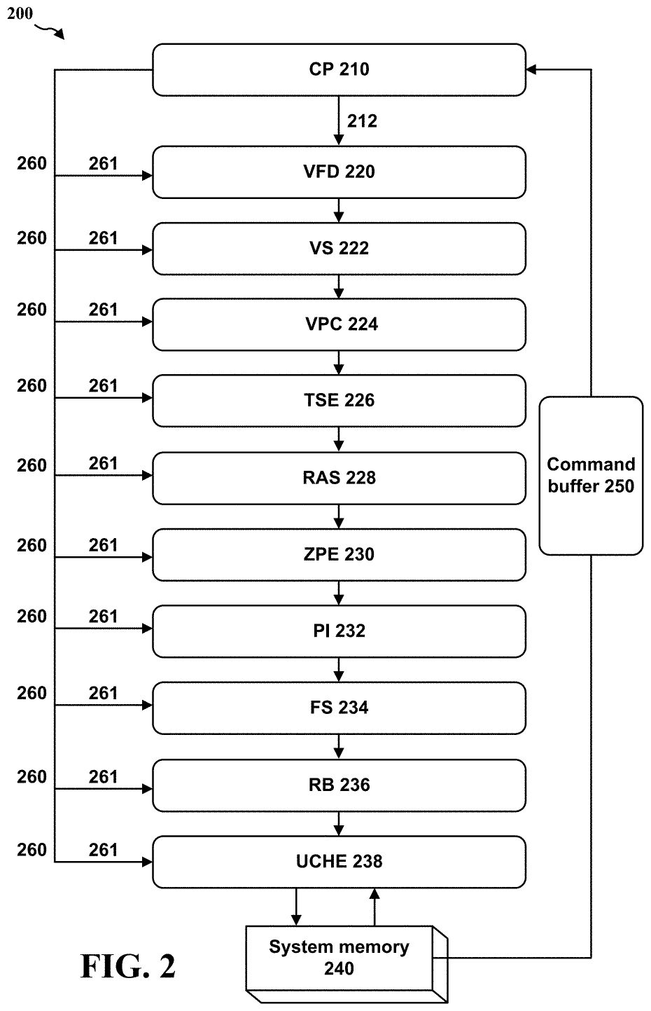

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can be structured in the following manner: context register of context N, draw call(s) of context N, context register of context N+1, and draw call(s) of context N+1.

Aspects of mobile devices or smart phones can utilize buffer mechanisms to distribute or coordinate a buffer between an application rendering side of the device, e.g., a GPU or CPU, and a display or composition side of the device, e.g., a display engine. For instance, some mobile devices can utilize a buffer queue mechanism to distribute or coordinate a buffer between an application rendering side and a display or composition side, which can include a buffer compositor or a hardware composer (HWC). In some aspects, the application rendering side can be referred to as a producer, while the display or composition side can be referred to as a consumer. Additionally, a synchronization divider or fence can be used to synchronize content between the application rendering side and the display or composition side. Accordingly, a fence can be referred to as a synchronization divider, and vice versa.

A variety of factors can be performance indicators for display processing between an application rendering side and a display or composition side. For instance, frames per second (FPS) and janks, i.e., delays or pauses in frame rendering or composition, are key performance indicators (KPI). In some aspects, a jank can be a perceptible pause in the rendering of a software application's user interface. Both FPS and janks are KPIs in game performance and/or device display capability. In some applications, janks can be the result of a number of factors, such as slow operations or poor interface design. In some instances, a jank can also correspond to a change in the refresh rate of the display at the device. Janks are important to gaming applications because if the display fresh latency is not stable, this can impact the user experience. Accordingly, some aspects of the mobile gaming industry are focused on reducing janks and increasing FPS.

Application can run at a variety of different FPS modes. In some aspects, applications can run at 30 FPS mode. In other aspects, applications can run at different FPS modes, e.g., 20 or 60 FPS. Aspects of the present disclosure can include a current frame latency time, which can refer to the time difference between when a previous frame completes being displayed and when a current frame completes being displayed. The frame latency time can also refer to the time between successive refreshing frames. The frame latency time can also be based on a frame rate. For instance, the frame latency time for each frame can be 33.33 ms (e.g., corresponding to 30 FPS), 16.67 ms (e.g., corresponding to 60 FPS), or 50 ms (e.g., corresponding to 20 FPS). Jank reduction technology can be utilized in a number of different scenarios. For instance, slow frames, e.g., frames under 30 FPS, may optimize janks reduction differently than fast frames. For example, there may be frame pacing issues for frames under 30 FPS, which may utilize a different janks reduction technology than faster frames. In some aspects, different mechanisms or designs may have the ability to detect janks. Also, once janks are detected, other mechanisms can be triggered. For example, a compositor can be directly triggered to bypass a vertical synchronization (Vsync) time in order to avoid janks. In some aspects, the threshold of the janks reduction technology may be platform dependent, which may need certain tuning efforts.

As indicated herein, if a frame takes too long to be rendered and is not ready for transmission to a display at a scheduled Vsync time, this can result in a delayed frame display time and a corresponding jank. As such, janks can be the result of a delayed frame rendering. In some aspects, a frame buffer or buffer queue can queue frames waiting to be sent to the display. If a frame takes too long to be rendered, then the frame may not be consumed or sent to the buffer queue by the scheduled Vsync time.

In some aspects, a compositor consume the frame or help send the frame buffer to the display. If the renderer takes too long to render a frame, then the compositor may be delayed in consuming the frame, so the frame will be delayed in being transmitted to the display. As such, a delay in rendering can cause a resulting delay in frame consumption or display transmission. In some aspects, if a frame has not finished rendering by a scheduled Vsync time, then the frame will not be consumed by the composer until the next Vsync time. In these aspects, if there are no frames in the buffer queue, then the compositor may not be triggered to consume the frame. As the frame is not consumed, this can result in a jank.

In display or frame processing, the display refresh rate can vary between the type of display panel, e.g., a 60 Hz, 90 Hz, or 120 Hz display panel. Also, a GPU rendering load can be increased when there are an increased amount of frames to be rendered, e.g., when there is a high refresh rate. For instance, high refresh rate panels can have a higher GPU rendering load compared to low refresh rate panels. For example, for a 120 Hz panel, there may be 8.33 ms to display the frame without a delay or jank. So for a high intensity application or game, the GPU rendering load may be too high to consistently render within a Vsync boundary. In these cases, there may be frame drops or janks.

In order to avoid frame drops or janks, adaptive synchronization methods or processes, e.g., Qsync, can be adopted. Adaptive synchronization methods can synchronize the display panel refresh to the GPU render rate, so that frames are displayed the moment they are rendered. This can occur if the frame rendering is not completed within the Vsync boundary.

In adaptive synchronization methods, the Vsync boundary can be extended or stretched until the GPU completes the frame rendering. For example, for a 120 Hz panel, the Vsync boundary can be extended from 8.33 ms to 10 ms. This can help to accommodate any delays in the GPU frame rendering or any new frame updates. In some instances, once the GPU frame rendering is completed, the adaptive synchronization can be signaled, and the frames can be rendered and displayed at a slight delay, e.g., 1 or 2 ms. This can be a helpful mechanism in ensuring a jank-free or tear-free game play when there are occasional rendering delays.

In some aspects, a display processor can refresh at each of multiple vertical synchronization (Vsync) times. For instance, at each Vsync time, the display processor can fetch all the application buffers, blend the buffers, and then send the buffers to a display panel. In some instances, the Vsync time may be fixed, which can refer to the refresh rate.

Additionally, a display processor can maintain a constant refresh rate when it is operated in video mode. In some instances, a layer refresh rate may be distinct from a display refresh rate. So the frequency of application or game updates may not be equivalent to the display refresh rate. Further, the user interface (UI) update frequency may vary for each application or game. In some aspects, a display processor may compose a set of input layers repeatedly to maintain a certain throughput, e.g., a 90 Hz or 120 Hz throughput. Also, repeated frame composition may result in a higher double data rate (DDR) utilization. To optimize DDR utilization, a display driver may switch to a lower frame refresh rate after composer idling, e.g., 70 ms of composer idling.

Some aspects of display or frame processing may include idling criteria that are more suited to certain types of displays, e.g., 30 Hz displays, which have a smaller refresh rate range. For instance, aspects of display or frame processing may not scale to other displays, e.g., 120 Hz displays, which have a wider refresh rate range, e.g., 30 to 120 Hz, as it can take up to four refresh cycles for the hardware to exit an idle state. Also, it may take up to eight cycles for display software to determine the composer inactive state and transfer to a lower refresh rate.

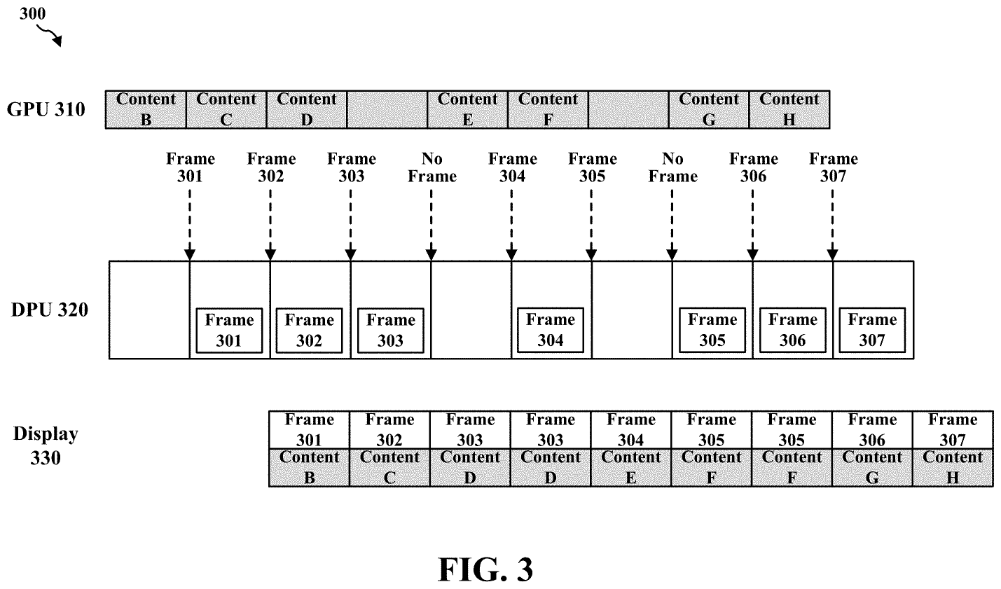

In addition, there may be interim idling cases, as shown in FIG. 3 below, which do not meet the idling criteria mentioned above. These idling cases may cause redundant frame refreshes. For example, there may be intermittent idling between the content updates at the display panel.

FIG. 3 illustrates diagram 300 of display or frame processing in accordance with one or more techniques of this disclosure. As shown in FIG. 3, diagram 300 includes GPU 310, DPU 320, and display 330. Diagram 300 also includes a number of different frames, e.g., frame 301, frame 302, frame 303, frame 304, frame 305, frame 306, and frame 307. These frames 301-307 may include a variety of content, e.g., content B-H, respectively.

As shown in FIG. 3, the top lines in diagram 300 display the content B-H rendered at the GPU 310. Frames 301-307 are then sent from the GPU 310 to the DPU 320. The middle lines display the DPU 320 or compositor consuming or processing each of the frames 301-307. When the DPU 320 or compositor consumes the frame, e.g., frames 301-307, it receives and processes the frame in order to program the hardware. Also, the bottom lines in diagram 300 show the DPU 320 transmitting frames 301-307 to the display 330. Display 330 then displays content B-H from respective frames 301-307.

As shown in FIG. 3, due to intermittent sleep modes or rendering delays, frames 303 and 305 may be repeated at the display 330. In turn, this may cause the display 330 to repeatedly display corresponding content D and F. So content D and F can be idling cases that cause redundant frame refreshes. As such, this illustrates an example of intermittent idling, i.e., when one or two frames are repeated at the display. As such, intermittent idling results in the same content being repeatedly displayed at the display panel.

As shown in FIG. 3, there is a constant Vsync time period, which includes a number of equally spaced Vsync times or vertical lines at the DPU 320. Accordingly, if there is a delay in rendering, then the same content will be repeated at the display at the next Vsync time. If the display refreshes at a fast rate, e.g., 120 Hz, then there may be intermittent idling if there is a delay in rendering or repeated frame. Also, the display may be energized by the DPU or compositor for a certain time period, e.g., 33 ms, prior to being energized again. For example, if a frame is rendered at a high refresh rate, e.g., 120 Hz at 8.33 ms, then the compositor may need to refresh the display panel again after a few frames, e.g., after four frames. So for these few frames, the panel may utilize a minimum refresh capability. In some instances, if there are frequent updates, then the panel may need to refresh at a faster rate.

As shown in FIG. 3, if the panel is operating at a certain frequency, e.g., 120 Hz, then a frame can be refreshed in a certain time period, e.g., 8.33 ms. As indicated above, the display panel pixels may be energized by the compositor once every certain time period, e.g., 33 ms. So at a 120 Hz frequency or 8.33 ms period, the compositor can energize the display panel pixels once every four frames. Also, the panel pixels may retain the charge every four frame cycles.

Once a frame is refreshed, the subsequent frames within a certain time period may not need to be refreshed. After this time period, the compositor may need to reenergize the panel pixels again. So once the compositor energizes the display panel, there is a flexibility for a certain number of frames, e.g., three or four frames, after this energizing. The display panel can rely on the compositor charge for a few frame cycles, and the subsequent frames may not need to be charged on time, i.e., arrive at the predetermined Vsync boundary. Therefore, as shown in FIG. 3 above, if frame 301 is charged by DPU 320, then frames 302 and 303 may be adjustable and may not need to arrive at the predetermined Vsync boundary.

Adaptive variable refresh rate (AVR) can allow frames to arrive at the display panel at adjustable times, i.e., not at a predetermined Vsync time. For example, if a panel supports a certain refresh rate, e.g., 30 Hz to 120 Hz refresh rate, then once the panel is charged, a frame can arrive anywhere in the corresponding period, e.g., from 8.33 ms to 33 ms. So AVR may allow the display panel to retain the charge from the compositor, so the frames can be sent to the panel within an adjustable time period. In turn, this may allow the GPU to experience rendering delays, while not resulting in duplicate frames displayed at the panel. For example, if a frame is sent to a display panel within a certain time period, e.g., 33 ms, then the panel can accommodate the frame.

Additionally, AVR can attempt to accommodate a frame within a certain time period, such as by extending the Vsync boundary. So if a display refresh rate is 120 Hz, and the GPU does not finish rendering a frame within 8.33 ms, then AVR can extend the Vsync boundary up to a certain time period, e.g., 33 ms. The AVR can allow the Vsync time periods to be extendable up to a certain time, such that a display panel may not need to display a duplicate frame.

On the display panel side, when the same content is being displayed, the panel can utilize AVR. For panels that support wider refresh rates, e.g., 30 Hz to 120 Hz refresh rates, the transfer from the hardware or system on chip (SoC) to the panel may occur at the higher refresh rate. For example, if a transfer occurs at 120 Hz, the hardware or SoC may be in sleep mode for the remaining time period. By optimizing this sleep mode, there can be a power savings gain. For instance, idle fallback or lowering the refresh rate can be triggered after a certain number of refresh cycles.

In some instances, AVR may be used to accommodate GPU rendering delays. Also, AVR mechanisms may trigger a Vsync signal immediately once a frame is processed or consumed. AVR mechanisms can also be used to handle intermittent sleep modes or avoid repeated frame refreshes. In order to take advantage of these intermittent sleep modes, AVR mechanisms may need to quickly enter into and/or exit out of intermittent idling mode. So AVR can be designed to accommodate rendering delays, such as by triggering a Vsync signal once the frame is processed or consumed. For example, for a 120 Hz refresh rate, if a frame is processed or consumed after a regular interval of 8.33 ms, e.g., 10 ms, then the Vsync may be triggered immediately at the frame processing time, e.g., 10 ms.

One problem with this use of AVR is that the application or game can expect a Vsync signal or pulse at a regular multiple of a fast refresh time, e.g., 8.33 ms, 16.67 ms, or 24.99 ms. As the application may expect the Vsync signal at these times, any intermittent idling can be performed without the knowledge of the application or game. For example, if the AVR mechanism sends a Vsync signal between regular time periods, e.g., 12 ms, then this may disturb or interrupt the application or game functioning.

Some aspects of AVR mechanisms can accommodate rendering delays by extending the Vsync duration. Hence, AVR mechanisms can trigger a Vsync signal once a frame is processed or composed. In order to reduce repeated frame refreshes, a Vsync duration may be extended such that a Vsync stretch period may remain aligned with the refresh rate period. Also, in order to keep a compositor scheduler synchronized with the hardware, Vsync interrupts may be triggered at a fast Vsync rate, even if a frame transfer is skipped.

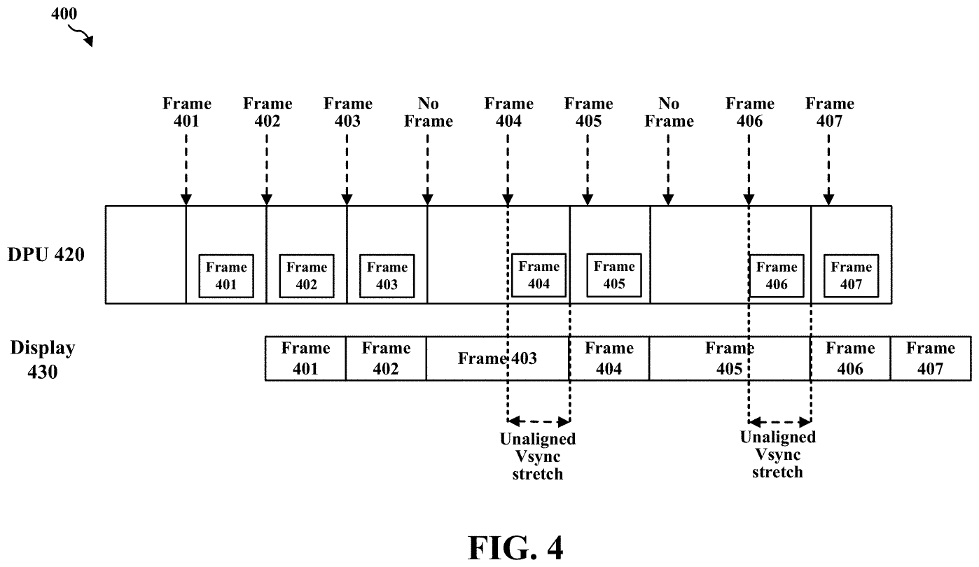

FIG. 4 illustrates diagram 400 of display or frame processing in accordance with one or more techniques of this disclosure. As shown in FIG. 4, diagram 400 includes DPU 420 and display 430. Diagram 400 also includes a number of different frames, e.g., frame 401, frame 402, frame 403, frame 404, frame 405, frame 406, and frame 407. These frames 401-407 may include a variety of content to be shown at the display 430.

As shown in FIG. 4, frames 401-407 are sent from a GPU to the DPU 420. FIG. 4 displays that the DPU 420 or compositor consumes or processes each of the frames 401-407. When the DPU 420 or compositor consumes the frame, e.g., frames 401-407, it receives and processes the frame in order to program the hardware. Also, diagram 400 shows that the DPU 420 transmits frames 401-407 to the display 430. Display 430 then shows the content for the respective frames 401-407. Frame 403 is displayed for a longer period at display 430, as there may be a sleep interval or rendering delay for frame 404. Also, the display 430 may remain charged for frame 403, as the compositor or DPU 420 charged the panel at a previous frame.

FIG. 4 shows one example of display or frame processing utilizing an AVR mechanism. As mentioned above, AVR mechanisms can extend or delay the duration of a Vsync signal or Vsync time period. AVR mechanisms can trigger Vsync signals once a frame is composed or processed. As shown in FIG. 4, when an AVR mechanism extends a Vsync time, it may cause the Vsync time period to become misaligned with a regular Vsync period. For example, FIG. 4 shows that frame 404 is consumed or processed after the regular Vsync period. In turn, this causes the AVR mechanism to extend the Vsync time period after frame 404 is consumed. Also, the Vsync signal may be sent immediately after frame 404 is consumed.

As shown in FIG. 4, if the Vsync signal is extended and does not align with the regular Vsync period, it may result in an unaligned Vsync stretch. FIG. 4 illustrates that the Vsync signal after frame 404 is consumed may be misaligned with the regular Vsync time period, which causes an unaligned Vsync stretch. As displayed in FIG. 4, this also occurs after frame 406 is consumed. As such, AVR mechanisms can result in multiple unaligned Vsync stretches. These unaligned Vsync stretches may also result in an unintended Vsync drift.

As indicated above, if a Vsync signal is sent at an irregular interval, there may be an unaligned Vsync stretch and/or an unintended Vsync drift. These unintended Vsync drifts and unaligned Vsync stretches are undesirable for applications or games. For example, if an application or game detects an unaligned Vsync stretch, then it may try to correct the frame timing, which can result in an unintended Vsync drift. Accordingly, an unaligned Vsync transmission may result in unpredictable application or game behavior. As such, the timing between the display and the application or game may become disrupted or interrupted.

As mentioned previously, these AVR mechanisms that transmit a Vsync signal immediately after a delayed frame is consumed, i.e., at irregular timing intervals, may result in negative consequences. So a delayed frame can cause an AVR mechanism to disrupt the timing of a frame cadence. For example, if a Vsync signal is sent at an irregular timing interval, the application rendering may disrupt the frame synchronization, and the frame cadence may be interrupted. Accordingly, there is a present need for an AVR mechanism to adjust a Vsync time period for extended frames to an expected or regular Vsync timing interval. Therefore, there is a present need for delayed Vsync signals that are sent at regular timing intervals.

Aspects of the present disclosure can utilize an AVR mechanism to adjust a Vsync time period to an expected Vsync timing interval. Aspects of the present disclosure can also transmit delayed Vsync signals at regular timing intervals. By doing so, the application rendering can be synchronized with the display panel, and the frame cadence can be maintained. So the present disclosure can utilize AVR mechanisms that avoid unintended Vsync drift and/or an unaligned Vsync stretch. As such, the present disclosure can avoid unpredictable application behavior, which may interrupt the timing between the display and the application or game. The present disclosure can also accomplish this for delayed or extended frames, e.g., during intermittent idling mode.

Aspects of the present disclosure can utilize an AVR mechanism based on a regular timing interval or aligned Vsync stretch. This may be an integral multiple of a fast Vsync rate, such that Vsync signals or pulses are aligned with a software frame scheduler. So the present disclosure may send a Vsync signal slightly after the frame is consumed, but not immediately after a frame is consumed. This can maintain the timing between the application and the display panel.

In some aspects of the present disclosure, AVR mechanisms can be enhanced to elongate or delay Vsync signals and/or trigger an AVR mechanism at discrete Vsync intervals. In some instances, a Vsync pulse may be signaled at regular Vsync durations, e.g., 8.33 ms, 16.67 ms, or 24.99 ms. Additionally, a driver may enable a proposed AVR mechanism by default, so that AVR may be triggered soon after a composer becomes idle. If enabled, the hardware can continue to trigger Vsync interrupts at fast Vsync intervals, i.e., when a composer scheduler is correcting drifts in the synchronization model. Moreover, a driver can trigger the proposed AVR mechanism as soon as a new frame is queued by a compositor. By doing so, the frame transfer can begin on the next Vsync boundary, in contrast to an instantaneous frame transfer. The driver may also enable the AVR mechanism if a frame is queued, but a GPU synchronization point is not signaled.

Aspects of the present disclosure can propose a number of hardware enhancements. For instance, aspects of the present disclosure can add a new AVR trigger mode that may select a scheduled frame on the next boundary of a Vsync period. Aspects of the present disclosure can also add a provision to generate Vsync interrupts on a regular Vsync boundary during a new AVR mode. This can also result in skipping redundant frame transfers.

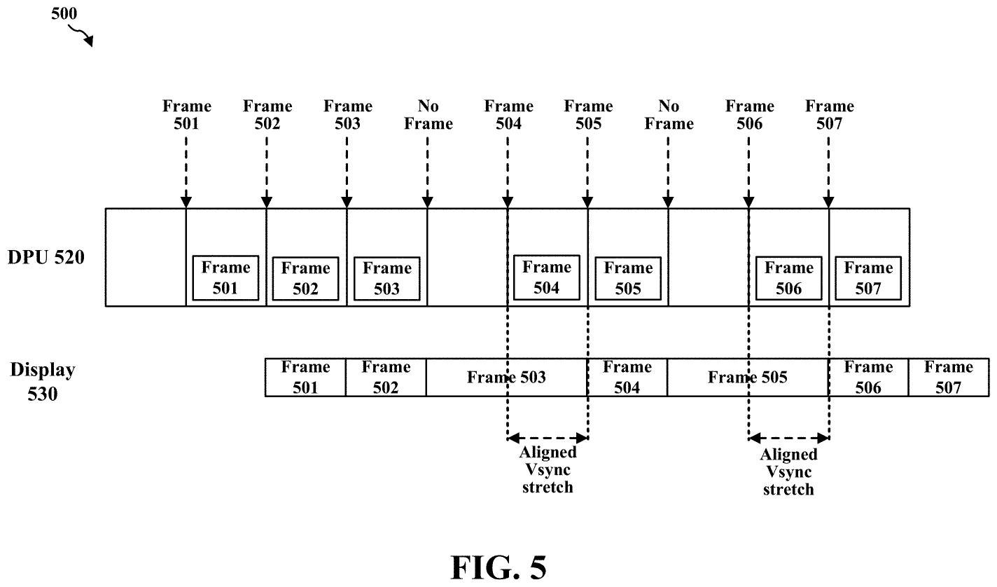

FIG. 5 illustrates diagram 500 of display or frame processing in accordance with one or more techniques of this disclosure. As shown in FIG. 5, diagram 500 includes DPU 520 and display 530. Diagram 500 also includes a number of different frames, e.g., frame 501, frame 502, frame 503, frame 504, frame 505, frame 506, and frame 507. These frames 501-507 may include a variety of content to be shown at the display 530.

As shown in FIG. 5, frames 501-507 are sent from a GPU to the DPU 520. FIG. 5 displays that the DPU 520 or compositor consumes or processes each of the frames 501-507. When the DPU 520 or compositor consumes the frame, e.g., frames 501-507, it receives and processes the frame in order to program the hardware. Also, diagram 500 shows that the DPU 520 transmits frames 501-507 to the display 530. Display 530 then shows the content for the respective frames 501-507. Frame 503 is displayed for a longer period at display 530, as there may be a sleep interval or rendering delay for frame 504. Also, the display 530 may remain charged for frame 503, as the compositor or DPU 520 charged the panel at a previous frame.

FIG. 5 shows one example of display or frame processing utilizing an AVR mechanism. As mentioned above, AVR mechanisms can extend or delay the duration of a Vsync signal or Vsync time period. In the present disclosure, AVR mechanisms can trigger Vsync signals after a frame is composed, in order to maintain a Vsync alignment. As shown in FIG. 5, when an AVR mechanism extends a Vsync time, the Vsync time period may remain aligned with the regular Vsync period. For example, FIG. 5 shows that frame 504 is consumed or processed after an initial Vsync signal, but aligned with the regular Vsync period at the subsequent Vsync signal. The AVR mechanism may extend the Vsync time period after frame 504 is consumed, e.g., extend an entire Vsync signal, to maintain Vsync alignment. As such, the Vsync signal may not be sent immediately after frame 504 is consumed, but rather at the subsequent regular Vsync interval.

As shown in FIG. 5, aspects of the present disclosure can send a Vsync signal after the frame is consumed, which may maintain the timing between the application and the display. In FIG. 5, the Vsync signal after frame 504 is delayed in order to align the Vsync signal with a Vsync timing alignment. Indeed, the present disclosure can adjust or align a delayed Vsync signal with a Vsync timing alignment. So the present disclosure can determine a Vsync timing alignment, and then adjust the delayed Vsync signal in order to align the Vsync signal with a pre-determined Vsync timing alignment. In some aspects, the application or game may desire to display a previous frame, e.g., frame 503, for a longer period of time than a delayed frame, e.g., frame 504.

As shown in FIG. 5, if the Vsync signal is extended and maintains alignment with the regular Vsync period, it may maintain an aligned Vsync stretch. FIG. 5 illustrates that the Vsync signal after frame 504 is consumed may be aligned with the regular Vsync time period, which maintains the aligned Vsync stretch. As displayed in FIG. 5, this can also occur after frame 506 is consumed. As such, AVR mechanisms can result in maintaining the alignment of Vsync stretches. These aligned Vsync stretches may not result in any unintended Vsync drift.

As indicated above, if a Vsync signal is sent at a regular Vsync timing interval, there may not be any unaligned Vsync stretch and/or any unintended Vsync drift. These aligned Vsync stretches are desirable for applications or games, as they maintain the synchronization with the display. For example, if a Vsync stretch is aligned for each Vsync pulse, then an application or game may not attempt to correct the frame timing. Accordingly, an aligned Vsync transmission may not result in any unpredictable application or game behavior. As such, the timing between the display and the application or game may remain stable and predictable.

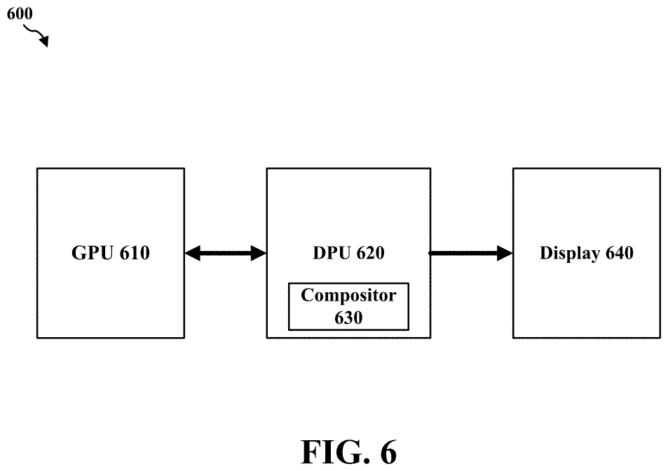

FIG. 6 illustrates diagram 600 in accordance with one or more techniques of this disclosure. More specifically, diagram 600 includes components of display or frame processing when utilizing AVR mechanisms. As shown in FIG. 6, diagram 600 includes graphics processing unit (GPU) 610, display processing unit (DPU) 620, compositor 630, and display 640. FIG. 6 illustrates the communication of each of these components during display or frame processing, such as when utilizing AVR mechanisms or adaptive Vsync timing.

As shown in FIG. 6, each of the components in diagram 600 can communicate with one or more additional components. For instance, the GPU 610 and the DPU 620 can communicate with each another. Moreover, the DPU 620 can communicate with the display 640. In some aspects, the DPU 620 can include the compositor 630.

As shown in FIG. 6, aspects of the present disclosure can include a number of different techniques when utilizing AVR mechanisms or adaptive Vsync timing. For instance, aspects of the present disclosure, e.g., GPUs, DPUs, compositors, frame compositors, display processors, or frame processors, herein, e.g., GPU 610, DPU 620, or compositor 630, can include a number of components when utilizing AVR mechanisms or adaptive Vsync timing. GPUs herein, e.g., GPU 610, can render a first frame, e.g., frame 504, prior to a frame ready time.

DPUs herein, e.g., DPU 620, may receive a first frame, e.g., frame 504, at a frame ready time associated with a current vertical synchronization (Vsync) time period including a first Vsync time and a second Vsync time, where the frame ready time may be between the first Vsync time and the second Vsync time, where the current Vsync time period may be distinct from one or more application Vsync time periods.

In some instances, the current Vsync time period may be misaligned with each of one or more application Vsync time periods. Also, the one or more application Vsync time periods may correspond to an application processing capability. Further, the one or more application Vsync time periods may be associated with one or more display refresh rates. The one or more display refresh rates may be equal to 30 Hz, 60 Hz, 90 Hz, or 120 Hz.

Additionally, DPUs herein, e.g., DPU 620, may process the first frame, e.g., frame 504, at the frame ready time. In some aspects, an adaptive variable refresh rate (AVR) mechanism may be triggered at the frame ready time. DPUs herein, e.g., DPU 620, may also receive a request for one or more Vsync signals based on the one or more application Vsync time periods. DPUs herein, e.g., DPU 620, may also generate the one or more Vsync signals based on the one or more application Vsync time periods.

Further, DPUs herein, e.g., DPU 620, may determine one of the one or more application Vsync time periods to align with the current Vsync time period based on the frame ready time. DPUs herein, e.g., DPU 620, may also select the one of the one or more application Vsync time periods to align with the current Vsync time period based on the frame ready time. DPUs herein, e.g., DPU 620, may also calculate an alignment of the current Vsync time period to align with the one of the one or more application Vsync time periods.

Moreover, DPUs herein, e.g., DPU 620, may adjust an alignment of the current Vsync time period to align with the one of the one or more application Vsync time periods. In some aspects, the alignment of the current Vsync time may be adjusted by a compositor or a DPU, e.g., DPU 620.

DPUs herein, e.g., DPU 620, may also adjust the second Vsync time to align the current Vsync time period with the one of the one or more application Vsync time periods. In some aspects, adjusting the second Vsync time may further comprise extending or delaying the second Vsync time. Also, adjusting the second Vsync time may align the first frame, e.g., frame 504, between the first Vsync time and the second Vsync time. DPUs herein, e.g., DPU 620, may also send the first frame, e.g., frame 504, to a display panel, e.g., display 530, at the second Vsync time.

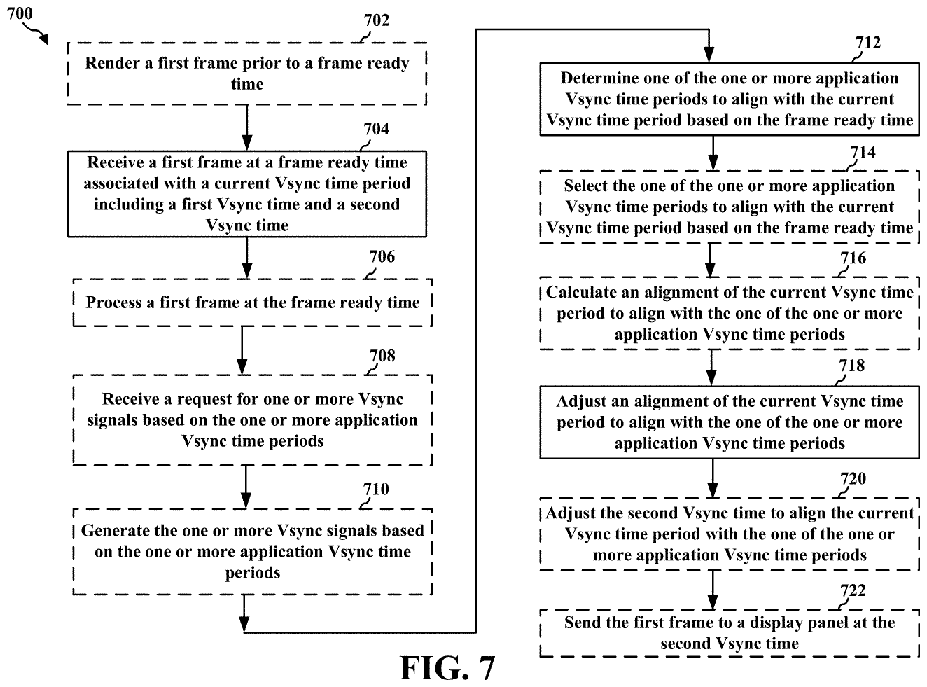

FIG. 7 illustrates an example flowchart 700 of an example method in accordance with one or more techniques of this disclosure. The method may be performed by an apparatus, e.g., a GPU, a DPU, a compositor, a frame processor, a display processor, or an apparatus for frame or graphics processing.

At 702, the apparatus may render a first frame prior to a frame ready time, as described in connection with the examples in FIGS. 3-6.

At 704, the apparatus may receive a first frame at a frame ready time associated with a current vertical synchronization (Vsync) time period including a first Vsync time and a second Vsync time, where the frame ready time may be between the first Vsync time and the second Vsync time, where the current Vsync time period may be distinct from one or more application Vsync time periods, as described in connection with the examples in FIGS. 3-6.

In some instances, the current Vsync time period may be misaligned with each of one or more application Vsync time periods, as described in connection with the examples in FIGS. 3-6. Also, the one or more application Vsync time periods may correspond to an application processing capability, as described in connection with the examples in FIGS. 3-6. Further, the one or more application Vsync time periods may be associated with one or more display refresh rates, as described in connection with the examples in FIGS. 3-6. The one or more display refresh rates may be equal to 30 Hz, 60 Hz, 90 Hz, or 120 Hz, as described in connection with the examples in FIGS. 3-6.

At 706, the apparatus may process the first frame at the frame ready time, as described in connection with the examples in FIGS. 3-6. In some aspects, an adaptive variable refresh rate (AVR) mechanism may be triggered at the frame ready time, as described in connection with the examples in FIGS. 3-6.

At 708, the apparatus may receive a request for one or more Vsync signals based on the one or more application Vsync time periods, as described in connection with the examples in FIGS. 3-6.

At 710, the apparatus may generate the one or more Vsync signals based on the one or more application Vsync time periods, as described in connection with the examples in FIGS. 3-6.

At 712, the apparatus may determine one of the one or more application Vsync time periods to align with the current Vsync time period based on the frame ready time, as described in connection with the examples in FIGS. 3-6.

At 714, the apparatus may select the one of the one or more application Vsync time periods to align with the current Vsync time period based on the frame ready time, as described in connection with the examples in FIGS. 3-6.

At 716, the apparatus may calculate an alignment of the current Vsync time period to align with the one of the one or more application Vsync time periods, as described in connection with the examples in FIGS. 3-6.

At 718, the apparatus may adjust an alignment of the current Vsync time period to align with the one of the one or more application Vsync time periods, as described in connection with the examples in FIGS. 3-6. In some aspects, the alignment of the current Vsync time may be adjusted by a compositor or a display processing unit (DPU), as described in connection with the examples in FIGS. 3-6.

At 720, the apparatus may adjust the second Vsync time to align the current Vsync time period with the one of the one or more application Vsync time periods, as described in connection with the examples in FIGS. 3-6. In some aspects, adjusting the second Vsync time may further comprise extending or delaying the second Vsync time, as described in connection with the examples in FIGS. 3-6. Also, adjusting the second Vsync time may align the first frame between the first Vsync time and the second Vsync time, as described in connection with the examples in FIGS. 3-6.

At 722, the apparatus may send the first frame to a display panel at the second Vsync time, as described in connection with the examples in FIGS. 3-6.

In one configuration, a method or apparatus for graphics processing is provided. The apparatus may be a GPU, a DPU, a CPU, a compositor, a frame compositor, a frame processor, a display processor, or an apparatus for frame or graphics processing. In one aspect, the apparatus may be the processing unit 120 within the device 104, or may be some other hardware within device 104 or another device. The apparatus may include means for receiving a first frame at a frame ready time associated with a current vertical synchronization (Vsync) time period including a first Vsync time and a second Vsync time, the frame ready time being between the first Vsync time and the second Vsync time, the current Vsync time period being distinct from one or more application Vsync time periods. The apparatus may also include means for determining one of the one or more application Vsync time periods to align with the current Vsync time period based on the frame ready time. The apparatus may also include means for adjusting an alignment of the current Vsync time period to align with the one of the one or more application Vsync time periods. The apparatus may also include means for adjusting the second Vsync time to align the current Vsync time period with the one of the one or more application Vsync time periods. The apparatus may also include means for calculating the alignment of the current Vsync time period to align with the one of the one or more application Vsync time periods. The apparatus may also include means for receiving a request for one or more Vsync signals based on the one or more application Vsync time periods. The apparatus may also include means for generating the one or more Vsync signals based on the one or more application Vsync time periods. The apparatus may also include means for selecting the one of the one or more application Vsync time periods to align with the current Vsync time period based on the frame ready time. The apparatus may also include means for rendering the first frame prior to the frame ready time. The apparatus may also include means for processing the first frame at the frame ready time. The apparatus may also include means for sending the first frame to a display panel at the second Vsync time.

The subject matter described herein can be implemented to realize one or more benefits or advantages. For instance, the described display processing techniques can be used by compositors, frame compositors, frame processors, display processors, DPUs, GPUs, CPUs, or other frame or graphics processors to enable the aforementioned AVR methods and processes. This can also be accomplished at a low cost compared to other display or frame processing techniques. Moreover, the frame or display processing techniques herein can improve or speed up data processing or execution. Further, the frame or display processing techniques herein can improve the data utilization and/or resource efficiency of a DPU or GPU. Additionally, the frame or display processing techniques herein can include AVR methods that can align a current Vsync timing period with one or more application Vsync time periods.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method of display processing, comprising:
receiving a first frame at a frame ready time associated with a current vertical synchronization (Vsync) time period including a first Vsync time and a second Vsync time, the frame ready time being between the first Vsync time and the second Vsync time, the current Vsync time period being distinct from one or more application Vsync time periods;
determining one of the one or more application Vsync time periods to align with the current Vsync time period based on the frame ready time; and
adjusting an alignment of the current Vsync time period to align with the one of the one or more application Vsync time periods.

2. The method of claim 1, further comprising:
adjusting the second Vsync time to align the current Vsync time period with the one of the one or more application Vsync time periods.

3. The method of claim 2, wherein adjusting the second Vsync time further comprises extending or delaying the second Vsync time.

4. The method of claim 2, wherein adjusting the second Vsync time aligns the first frame between the first Vsync time and the second Vsync time.

5. The method of claim 1, wherein an adaptive variable refresh rate (AVR) mechanism is triggered at the frame ready time.

6. The method of claim 1, wherein the one or more application Vsync time periods correspond to an application processing capability.

7. The method of claim 1, further comprising:
calculating the alignment of the current Vsync time period to align with the one of the one or more application Vsync time periods.

8. The method of claim 1, wherein the current Vsync time period is misaligned with each of one or more application Vsync time periods.

9. The method of claim 1, further comprising:
receiving a request for one or more Vsync signals based on the one or more application Vsync time periods.

10. The method of claim 9, further comprising:
generating the one or more Vsync signals based on the one or more application Vsync time periods.

11. The method of claim 1, further comprising:
selecting the one of the one or more application Vsync time periods to align with the current Vsync time period based on the frame ready time.

12. The method of claim 1, wherein the one or more application Vsync time periods are associated with one or more display refresh rates.

13. The method of claim 12, wherein the one or more display refresh rates are equal to 30 Hz, 60 Hz, 90 Hz, or 120 Hz.

14. The method of claim 1, further comprising:
rendering the first frame prior to the frame ready time.

15. The method of claim 1, further comprising:
processing the first frame at the frame ready time.

16. The method of claim 1, further comprising:
sending the first frame to a display panel at the second Vsync time.

17. The method of claim 1, wherein the alignment of the current Vsync time is adjusted by a compositor or a display processing unit (DPU).

18. An apparatus for display processing, comprising:
a memory; and
at least one processor coupled to the memory and configured to:
receive a first frame at a frame ready time associated with a current vertical synchronization (Vsync) time period including a first Vsync time and a second Vsync time, the frame ready time being between the first Vsync time and the second Vsync time, the current Vsync time period being distinct from one or more application Vsync time periods;
determine one of the one or more application Vsync time periods to align with the current Vsync time period based on the frame ready time; and
adjust an alignment of the current Vsync time period to align with the one of the one or more application Vsync time periods.

19. The apparatus of claim 18, wherein the at least one processor is further configured to:
adjust the second Vsync time to align the current Vsync time period with the one of the one or more application Vsync time periods.

20. The apparatus of claim 19, wherein adjusting the second Vsync time further comprises extending or delaying the second Vsync time.

21. The apparatus of claim 19, wherein adjusting the second Vsync time aligns the first frame between the first Vsync time and the second Vsync time.

22. The apparatus of claim 18, wherein an adaptive variable refresh rate (AVR) mechanism is triggered at the frame ready time.

23. The apparatus of claim 18, wherein the one or more application Vsync time periods correspond to an application processing capability.

24. The apparatus of claim 18, wherein the at least one processor is further configured to:
calculate the alignment of the current Vsync time period to align with the one of the one or more application Vsync time periods.

25. The apparatus of claim 18, wherein the current Vsync time period is misaligned with each of one or more application Vsync time periods.

26. The apparatus of claim 18, wherein the at least one processor is further configured to:
receive a request for one or more Vsync signals based on the one or more application Vsync time periods; and
generate the one or more Vsync signals based on the one or more application Vsync time periods.

27. The apparatus of claim 18, wherein the at least one processor is further configured to:
select the one of the one or more application Vsync time periods to align with the current Vsync time period based on the frame ready time.

28. The apparatus of claim 18, wherein the one or more application Vsync time periods are associated with one or more display refresh rates, wherein the one or more display refresh rates are equal to 30 Hz, 60 Hz, 90 Hz, or 120 Hz.

29. An apparatus for display processing, comprising:
means for receiving a first frame at a frame ready time associated with a current vertical synchronization (Vsync) time period including a first Vsync time and a second Vsync time, the frame ready time being between the first Vsync time and the second Vsync time, the current Vsync time period being distinct from one or more application Vsync time periods;
means for determining one of the one or more application Vsync time periods to align with the current Vsync time period based on the frame ready time; and
means for adjusting an alignment of the current Vsync time period to align with the one of the one or more application Vsync time periods.

30. A computer-readable medium storing computer executable code for display processing, comprising code to:
receive a first frame at a frame ready time associated with a current vertical synchronization (Vsync) time period including a first Vsync time and a second Vsync time, the frame ready time being between the first Vsync time and the second Vsync time, the current Vsync time period being distinct from one or more application Vsync time periods;
determine one of the one or more application Vsync time periods to align with the current Vsync time period based on the frame ready time; and
adjust an alignment of the current Vsync time period to align with the one of the one or more application Vsync time periods.
